(19) United States
(12) Patent Application Publication
(10) Pub. No.: US 2011/0185631 A1
(43) Pub. Date: Aug. 4, 2011

(54) Systems and Methods of Pelletizing Heavy Hydrocarbons

(75) Inventors: Anand Subramanian, Sugar Land, TX (US); Raymond H. Floyd, Katy, TX (US); Vasant K. Patel, Sugar Land, TX (US)

(73) Assignee: KELLOGG BROWN & ROOT LLC, Houston, TX (US)

(21) Appl. No.: 12/699,325

(22) Filed: Feb. 3, 2010

(51) Int. Cl. C10L 5/06; B29B 9/00

(52) U.S. Cl. 44/593; 425/6

(57) ABSTRACT

Systems and methods for pelletizing a molten heavy hydrocarbon that can be extruded from a drop former to create a plurality of droplets that are subsequently quenched in a cooling media to create asphaltenic pellets. The asphaltenic pellets can be solidified by transferring heat from the droplets to the cooling media to provide the solid asphaltenic pellets. The solid asphaltenic pellets can then be separated from the cooling media which can be recycled for use.

### BACKGROUND OF THE INVENTION

1. Field of the Invention

Embodiments provided herein generally relate to systems and methods for cooling and solidifying asphaltenes. More particularly, embodiments provided herein relate to the extrusion and quenching of molten hydrocarbons.

2. Description of the Related Art

Heavy hydrocarbons, such as high molecular weight, viscous, non-Newtonian fluids are produced during extraction and refining processes. Such heavy hydrocarbons typically require dilution prior to transport. Often, one or more lighter hydrocarbons such as diesel fuel are added to reduce the viscosity and improve the pumpability and facilitate the transport of heavy hydrocarbons. Alternatively, heavy hydrocarbons can be deasphalted using one or more solvent deasphalting processes, such as the Residuum Oil Supercritical Extraction (“ROSE”) treatment process. During a typical solvent deasphalting process, the heavy hydrocarbons are introduced to a solvent extraction process wherein high viscosity asphaltenes and resins (“asphaltenic hydrocarbons”) are separated and removed, providing a low viscosity deasphalted oil. Similar asphaltenic hydrocarbons can be generated during other heavy hydrocarbon refining processes. While generated using two different processes, i.e., solvent extraction and/or refining, the asphaltenic hydrocarbons share similar characteristics. Both are rich in heavy molecular weight hydrocarbons, which at ambient temperatures are solid or semi-solid, both require elevated temperatures to maintain pumpability, and both require dilution to provide one or more fungible products.

Where local upgrading facilities are unavailable or capacity-limited, the asphaltenic hydrocarbons must be transported via truck, rail, or pipeline to one or more remote upgrading facilities. Asphaltenic hydrocarbons are often maintained at elevated temperatures to permit pumpable loading and unloading of the liquid or semi-solid asphaltenic hydrocarbons to/from truck, rail, and/or pipeline. The need to maintain the asphaltenic hydrocarbons at elevated temperatures throughout transport increases operation costs, complicates the process, and risks solidification of the asphaltenic hydrocarbons should the temperature decrease. Solidified asphaltenic hydrocarbons have a tendency to plug pipelines which can require extensive maintenance and/or cleaning of the pipelines and any transport vehicles, such as trucks and rail wagons.

As an alternative to fluid or semi-solid transport, the asphaltenic hydrocarbons can be cooled in bulk and solidified prior to transport. However, bulk solidification, loading, transport, and unloading of bulk solidified materials can be cost, labor, and maintenance intensive. To minimize special equipment and/or handling requirements, the asphaltenic hydrocarbons can alternatively be solidified into smaller particulates or pellets prior to transport.

Various methods for pelletizing heavy hydrocarbons have been developed. For example, a molten heavy hydrocarbon can be pumped out a nozzle and formed into a series of droplets upon falling into a bath of cooling media flowing beneath the hydrocarbon distributor. Alternatively, one or more wetted pelletizers can be used to provide relatively uniform heavy hydrocarbon solids by “spraying” a molten asphaltenic hydrocarbon through a rotary head to form a plurality of hydrocarbon droplets. The individual hydrocarbon droplets are air-cooled while in flight, thereby solidifying into hydrocarbon pellets as they impact and flow down the walls of the wetted pelletizer into an underlying cooling fluid bath.

The usefulness of the cooling bath or the wetted pelletizer is limited, however, based upon the variable specific gravity of the hydrocarbon pellets, which can range from less than water (i.e., a specific gravity of less than 1.0 or an API density of greater than 10°) to greater than water (i.e., a specific gravity of greater than 1.0 or an API density of less than 10°). The formation of both floating and sinking hydrocarbon pellets within the cooling fluid cooling channel makes the separation and removal of the pellets difficult since the floating pellets tend to agglomerate forming large masses, which are not amenable to removal from the cooling fluid cooling channel particularly where the cooling channel is located within an enclosed vessel.

Therefore, there exists a continuing need for improved systems and methods for pelletizing heavy hydrocarbons.

### BRIEF DESCRIPTION OF THE DRAWINGS

So that the recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a side view of an illustrative system for pelletizing heavy hydrocarbons, according to one or more embodiments of the present disclosure.

FIG. 2 depicts a front view of the illustrative system for pelletizing heavy hydrocarbons as shown in FIG. 1.

FIG. 3 depicts an illustrative system for pelletizing heavy hydrocarbons, according to another embodiment of the present disclosure.

FIG. 4 depicts an illustrative system for pelletizing heavy hydrocarbons, according to another embodiment of the present disclosure.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with publicly available information and technology.

Systems and methods for pelletizing heavy hydrocarbons, such as asphaltenes, are provided. In at least one embodiment, hot asphaltenes can be extruded through a drop former and deposited onto a conveyor belt there below to form droplets. The droplet can be subsequently quenched in a cooling media to solidify the droplets into asphaltenic pellets. In one or more embodiments, the asphaltenic pellets can be separated from the cooling media and recovered as cooled, solid particles for transport or use.

As used herein, the terms “asphaltene,” “asphaltenes,” “asphaltenic,” and “asphaltenic hydrocarbons,” can be used interchangeably and refer to a hydrocarbon mixture containing one or more heavy hydrocarbons that are insoluble in light, paraffinic, solvents, such as pentane and heptane, but are soluble in aromatic compounds such as toluene. The heavy hydrocarbons can include one or more aromatic and/or naphthenic compounds containing an average of about 50 to about 80 carbon, nitrogen, sulfur, and oxygen atoms.

As used herein, the terms “solid asphaltenic particles,” “solid asphaltene particles”, and “solid particles” can refer to any of the following: solid asphaltene particles, semi-solid asphaltene particles, and composite asphaltene particles having a solid asphaltene ‘skin’ surrounding a molten asphaltene ‘core.’

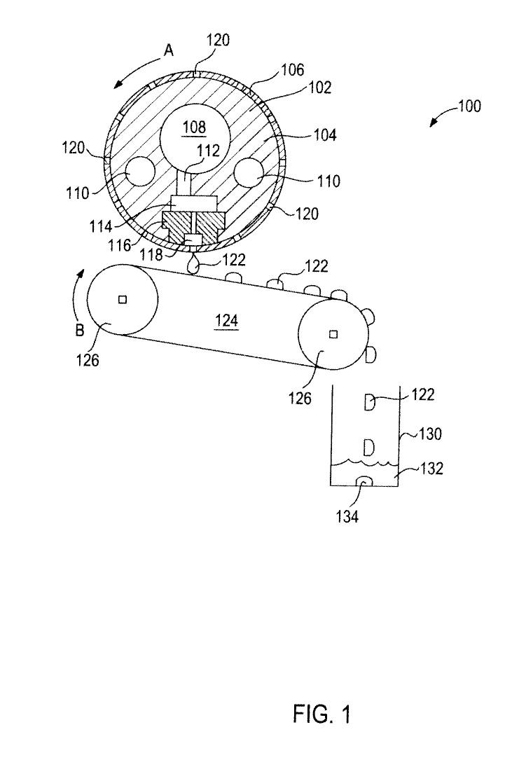

FIG. 1 depicts an end view of an illustrative asphaltene pelletization system 100, according to at least one embodiment of the disclosure. The system 100 can include a drop former 102 having a stator 104 and a rotary outer drum 106. The stator 104 can be nested within the rotary outer drum 106, while the rotary outer drum 106 can be configured to concentrically-rotate with respect to the stator 104. The stator 104 can include an axially-disposed feed channel 108 configured to receive a low-viscosity flowable mass from a vessel or supply pipe (not shown). In at least one embodiment, the flowable mass can include a hot heavy hydrocarbon that is a solid at ambient temperatures. For example, the heavy hydrocarbon can include an asphaltene, but can also include any hot liquid that is a solid at near ambient, or room temperatures, such as residues from various refining processes. In an embodiment, the flowable mass can be pumped under pressure into the feed channel 108 from one end of the stator 104, and eventually extruded for pelletization, as described below.

The temperature of the heavy hydrocarbon, or asphaltenes, introduced into the feed channel 108 can range from about 210° C. to about 430° C., from about 210° C. to about 370° C., or from about 210° C. to about 315° C. The pressure of the molten asphaltenes can vary greatly and may depend on the upstream processing requirements. In at least one embodiment, the pressure can be about atmospheric pressure, and can range from about 101 kPa to about 2,160 kPa, about 300 kPa to about 1,820 kPa, or from about 500 kPa to about 1,475 kPa.

In at least one embodiment, the stator 104 can also include at least one heater module 110 (two heaters 110 are shown) configured to maintain the molten asphaltenes an elevated temperature while inside the stator 104. In operation, the heater module 110 can have a heated medium continuously routed through it, thereby serving as a heat exchanger. The heater module 110 can also include a heater coil or similar heating device similarly configured to maintain an elevated temperature of the molten asphaltenes.

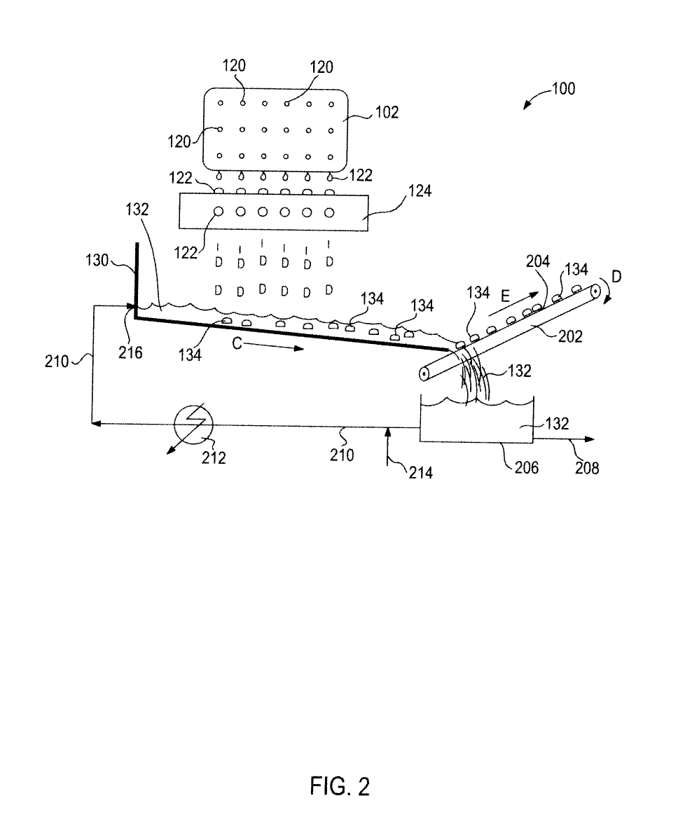

A bore 112, or series of bores, can be communicably coupled to the feed channel 108 and extend to a duct 114 configured to feed the molten asphaltenes into a nozzle 116 that is mounted to the stator 104. The nozzle 116 can include a downwardly-open channel 118 configured to coincide cyclically with a plurality of perforations 120 defined around the periphery of the rotary outer drum 106. As is more aptly shown in FIG. 2, there can be several perforations 102 defining several rows around the periphery of the rotary outer drum 106.

Still referring to FIG. 1, the molten asphaltenes can be pumped under pressure to the feed channel 108 of the drop former 102. The molten asphaltenes may then flow through the stator 104 to the nozzle 116 where it is directed to the downwardly-open channel 118. A system for baffles and internal nozzles (not shown) built into the stator 104 can impart a uniform pressure across the whole width of the channel 118, thereby providing an even flow through each row of perforations 120 defined in the rotary outer drum 106 as it rotates in the direction of arrow A. As the rotary outer drum 106 turns concentrically around the stator 104, droplets 122 of molten asphaltenes can be extruded from the drop former 102 and deposited on a variety of transfer surfaces below.

In at least one embodiment, a suitable transfer surface can include a conveyor belt 124 located directly beneath the drop former 102. The drop former 102 can be configured to deposit droplets 122 across the operating width of the conveyor belt 124 (as also illustrated in FIG. 2). The conveyor belt 124 can be rotated in direction B by a pair of rollers 126 at each end. In at least one embodiment, the conveyor belt 124 can be fabricated from any metal and/or metal alloy, including, but not limited to, steel, aluminum, stainless steel, brass, bronze or any other metal and/or metal alloy resistant to potential corrosive effects of the cooling media and hydrocarbons. Although not necessary, in at least one embodiment, the circumferential speed of the rotary outer drum 106 can be synchronized with the speed of the conveyor belt 124 below, thereby ensuring that the droplets 122 are deposited in a uniform size from one edge of the belt 124 to the other.

As illustrated, the conveyor belt 124 can be declined slightly, relative to horizontal. In other embodiments, the conveyor belt 124 can be parallel to the ground to suit other applications. As the conveyor belt 124 rotates in direction B, the droplets 122 can eventually fall off the conveyor belt 124 and drop into a cooling channel 130 containing a cooling media 132. While traveling on and falling from the conveyor belt 124, the droplets 122 can begin to externally cool, forming an external “skin.” Upon contacting the cooling media 132, the droplets 122 will rapidly quench and solidify into asphaltenic pellets 134 that can be separated and collected, as described below.

In an embodiment, the cooling media 132 can include water, brine, one or more C₅ to C₉ paraffins, or mixtures thereof. The temperature of the cooling media 132 can range from about 0° C. to about 100° C., from about 0° C. to about 75° C., or from about 0° C. to about 50° C., depending on the heat requirements of the system.

FIG. 2 depicts a front view of the illustrative system for pelletizing heavy hydrocarbons as shown in FIG. 1. As shown, a cooling channel 130 can be disposed at a decline with respect to horizontal, thereby allowing the cooling media 132 to continuously flow “downhill” in direction C within the cooling channel 130. As such, the flow regime of the cooling media 132 can be laminar, transitional, or turbulent, i.e. having any Reynolds number. In one or more embodiments, the cooling media 132 flowing through the cooling channel 130 can be in a laminar flow regime, having a Reynolds number of less than 2,000. In one or more embodiments, the cooling media 132 can be in a turbulent flow regime, having a Reynolds number greater than 4,000. In one or more embodiments, the velocity of the cooling media 132 through the cooling channel 130 can range from about 0.1 msec to about 10 msec, from about 0.2 msec to about 7 msec, or from about 0.3 msec to about 5 m/sec.

In an embodiment, the depth of the cooling media 132 flowing in the cooling channel 130 can range from about ¼ inch to about 2 inches, or from about ¼ inch to about 1 inch, or from about ¼ inch to about ½ inch. In other embodiments, the depth of the cooling media 132 can include at least a depth sufficient to submerge the droplets 122. As can be appreciated, other embodiments can include adjusting the angle of decline of the cooling channel 130 to increase or decrease the amount of time the cooling media 132 flows within the cooling channel 130. In at least one embodiment, the cooling channel 130 can be disposed substantially horizontal, or even at an incline, and rely solely on an inlet pressure of the cooling media 132 to force/flow the asphaltenic pellets 134 in direction C.

In operation, the drop former 102 extrudes the molten asphaltenes from the plurality of perforations 120 to form droplets 122 that are dropped onto the continuously-moving conveyor belt 124 located there below, as described above. The droplets 122 can then fall off the conveyor belt 124 and into the cooling media 132 of the cooling channel 130 where they are quenched into solid asphaltenic pellets 134. Since the cooling media 132 flows in direction C, the resulting current can have the effect of forcing, or coursing, the quenched asphaltenic pellets 134 also in direction C toward a separator 202.

Although not illustrated herein, the disclosure also contemplates that include extruding the molten asphaltenes into droplets 122 that are dropped into a cooling channel 130 having a continuously-rotating conveyor (not illustrated) completely submerged in the cooling media 132. The submerged conveyor can be disposed at any angle that allows the transport of the quenched asphaltenic pellets 134 in direction C toward an adjacent separator 202.

The separator 202 can include any system, device, or combination of systems and/or devices suitable for conveying or separating at least a portion of the solid asphaltenic pellets 134 from the cooling media 132. The separator 202 can include an inclined conveyor belt 204 that continuously rotates in direction D. The conveyor belt 204, however, can be configured to allow the flow-through passage of cooling media 132, while prohibiting the passage of any asphaltenic pellets 134. For example, the conveyor belt 204 can include a screen having perforations large enough to allow the influx and passage of cooling media 132, but small enough to prevent the passage of asphaltenic pellets 134. As a result, the cooling media 132 can flow out of the cooling channel 130, through the conveyor belt 204, and into a reservoir 206, while the asphaltenic pellets 134 can be separated from the cooling channel 130 via the separator 202 in direction E. In one or more embodiments, the solid asphaltenic pellets 134 can be transported on the separator 202 to be collected or removed via mechanical transfer, e.g. shovels, bucket lift, or additional conveyors.

Many alterations and embodiments of the separator 202 are contemplated without departing from the spirit of the present disclosure. For example, the separator 202 need not be disposed at an incline relative to horizontal, but can be horizontally disposed or even at a decline. Moreover, the separator 202 can include a moving or vibrating screen (not shown), configured to sift and separate the asphaltenic pellets 134 from the cooling media 132. In at least one embodiment, the moving or vibrating screen can be disposed at a decline relative to horizontal to allow the separated asphaltenic pellets 134 to continuously move away from the cooling channel 130. In one or more embodiments, the separator 202 can include, but is not limited to, one or more strainers, basket filters, dewatering conveyors, recessed chamber filter presses, vibrating screens, oscillating screens, or any combination thereof, arranged in series and/or parallel.

The cooling rate of the solid asphaltenic pellets 134 can be controlled by adjusting the temperature of the cooling media 134. In one or more embodiments, the cooling rate of the solid asphaltenic pellets 134 can range from about PC/sec to about 100° C./sec, from about 1° C./sec to about 75° C./sec, or from about PC/sec to about 50° C./sec. In one or more embodiments, the residence time of the solid asphaltenic pellets 134 in contact with the cooling media 132 can range from about 2 seconds to about 180 seconds, from about 3 seconds to about 120 seconds, from about 4 seconds to about 60 seconds, or from about 5 seconds to about 30 seconds.

Still referring to FIG. 2, the cooling media 132 can be recycled via line 210 for subsequent reintroduction into the cooling channel 130. At least a portion of the cooling media 132 within the reservoir 206, however, can be removed and treated for discharge and/or disposal via line 208. To compensate for the loss of cooling media 132 via line 208, additional “make-up” media can be introduced via line 214 into line 210. In one or more embodiments, a minimum of 25% wt, 50% wt, 75% wt, 85% wt, 90% wt, 95% wt, or 99% wt of the cooling media 132 introduced to the reservoir 206 can be recycled via line 210.

Furthermore, although not shown in FIG. 2, at least a portion of the cooling media 132 recycled via line 210 can pass through one or more treatment and/or purification systems, such as a fines separation unit, to remove one or more contaminants including, but not limited to, accumulated solids, hydrocarbons, metals, dissolved salts, mixtures thereof, derivatives thereof, or any combination thereof.

In one or more embodiments, the temperature of at least a portion of the cooling media 132 recycled via line 210 can be adjusted using one or more heat transfer units 212. Exemplary heat transfer units 212 can include any system, device, or combination of systems and/or devices suitable for adjusting the temperature of the cooling media 132 in line 210 to provide recycled cooling media 132 in a predetermined temperature range. The one or more heat transfer units 212 can include one or more U-tube exchangers, shell-and-tube exchangers, plate and frame exchangers, spiral wound exchangers, fin-fan exchangers, evaporative coolers, or any combination thereof. The operating temperature of the one or more heat transfer units 212 can range from about 0° C. to about 90° C., from about 20° C. to about 75° C., or from about 30° C. to about 60° C. The operating pressure of the one or more heat transfer units 212 can range from about 101 kPa to about 2,160 kPa, from about 300 kPa to about 1,820 kPa, or from about 500 kPa to about 1,475 kPa.

The recycled cooling media 132 can be introduced to at least one fluid distributor 216 disposed in the cooling channel 130. Each fluid distributor 216 can be a weir, nozzle, or other device capable of delivering the required flow of cooling media 132 to the cooling channel 130. In an embodiment, the flowrate of the cooling media 132 can be regulated by adjusting the fluid distributor, thereby providing a desired residence time for the solid asphaltenic pellet 134 to be in contact with the cooling media 132. Furthermore, each fluid distributor 216 can also serve as a nozzle configured to propel the quenched asphaltenic pellets 134 towards the separator 202.

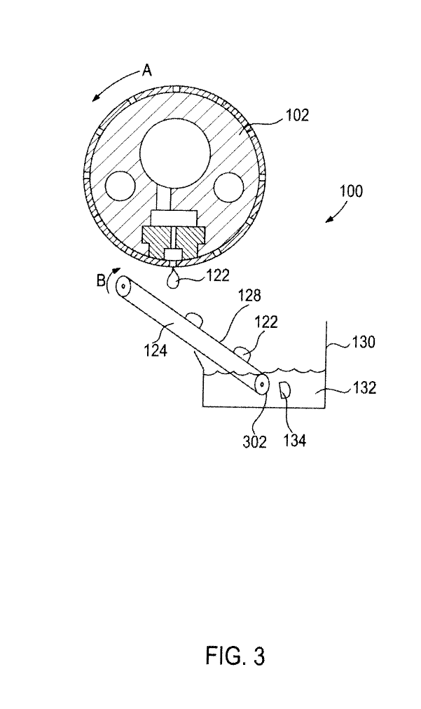

FIG. 3 depicts an illustrative system for pelletizing heavy hydrocarbons, according to another embodiment of the present disclosure. The drop former 102, conveyor belt 124, and cooling channel 130 can operate in a manner substantially similar to the descriptions provided above, and therefore will not be described in detail. At least one modification can include the angular disposition of the conveyor belt 124. As illustrated, the conveyor belt 124 can be angled or disposed such that one end 302 is at least partially immersed in the flow of the cooling media 132. Submerging a portion of the conveyor belt 124 can allow for a portion of heat transfer to occur between the surface of the belt 124 and the cooling media 132, thereby maintaining the conveyor belt 124 at a reduced temperature.

In operation, the molten asphaltene can be extruded from the drop former 102 onto the conveyor belt 124, as described above. The extruded droplets 122, however, can be transported directly into the cooling media 132. Upon contacting the cooling media 132, the droplets 122 can rapidly quench into asphaltenic pellets 134 and be swept into the current of the cooling media 132. Separation of the asphaltenic pellets 134 from the cooling media 132, and recycling of the cooling media 132 can also be implemented, as described above with reference to FIG. 2.

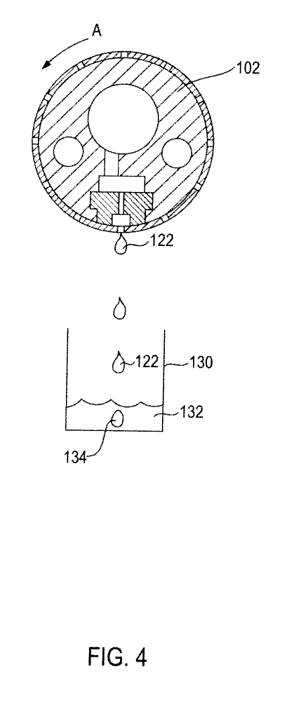

FIG. 4 depicts an illustrative system for pelletizing heavy hydrocarbons, according to another embodiment of the present disclosure. The drop former 102 and cooling channel 130 can operate in a manner substantially similar to the descriptions provided above, and therefore will not be described in detail. At least one modification can include the elimination of the conveyor belt 124 beneath the drop former 102. As can be appreciated, eliminating the conveyor belt 124 can save on machinery costs and overall operating expenses of the system 100.

In operation, the droplets 122 can be extruded from the drop former 102 and plunge directly into a cooling channel 130 disposed below. Similar to the embodiments disclosed above, the droplets 122 can be quenched and solidified into asphaltenic pellets 134 by the cooling media 132 located within the cooling channel 130. In at least one embodiment, the asphaltenic pellets 134 can be swept down the cooling channel 130 by a current caused by the flowing cooling media 132. Separation of the asphaltenic pellets 134 from the cooling media 132, and recycling of the cooling media 132 can also be implemented as described above.

Although not specifically illustrated, also contemplated in the present disclosure is the implementation of several equivalent pelletization systems 100, disposed in series or otherwise adjacent to each other, and using the same conveyor belt 124 or cooling channel 130 for creating asphaltenic pellets 134. In at least one embodiment, one system 100 can directly face another system 100 and be configured to continuously feed droplets 122 disposed on the respective conveyor belts 124 into a common cooling channel 130 or another conveying system (not shown) altogether. Because of the small size of the system 100, especially the overall length of the conveyor belt 124, when compared with other drop forming applications, a significant savings in initial capital investment and operating expenses can be achieved. Moreover, the small size of the system 100 frees up valuable plot size on the floor of an industrial facility; portions of which could be resourcefully used otherwise.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A method of pelletizing hot asphaltenes, comprising:
extruding an asphaltenic hydrocarbon from a drop former to form droplets;
depositing the asphaltenic hydrocarbon droplets on a conveyor adjacent to the drop former;
quenching the asphaltenic hydrocarbon droplets from the conveyor in a cooling media disposed in a cooling channel, thereby solidifying at least a portion of the asphaltenic hydrocarbon droplets by transferring heat from the asphaltenic hydrocarbon droplets to the cooling media to generate asphaltenic pellets; and
separating the asphaltenic pellets from the cooling media.

2. The method of claim 1, wherein the asphaltenic hydrocarbon comprises one or more hydrocarbon mixtures having one or more aromatic compounds, one or more naphthenic compounds, or a mixture of both.

3. The method of claim 1, wherein the asphaltenic hydrocarbon comprises one or more compounds insoluble in light, paraffinic, solvents and soluble in aromatic compounds.

4. The method of claim 1, wherein the cooling media continuously flows in the cooling channel, thereby coursing the asphaltenic pellets towards a conveyor system configured to separate the asphaltenic pellets from the cooling media.

5. The method of claim 1, wherein the cooling media has a temperature of from about 0° C. to about 95° C.

6. The method of claim 1, wherein the cooling media in the cooling channel has a depth of from about 0.25 to about 2 inches.

7. The method of claim 1, further comprising recycling at least a portion of the cooling media back into the cooling channel.

8. A method of pelletizing hot asphaltenes, comprising:
extruding an asphaltenic hydrocarbon from a drop former to form droplets;
depositing the droplets into a cooling channel having a cooling media flowing therein, wherein the cooling channel is disposed at a decline with respect to horizontal;
quenching the droplets in the cooling media by transferring heat from the droplets to the cooling media to form solid asphaltenic pellets; and
removing the solid asphaltenic pellets from the cooling media.

9. The method of claim 8, wherein the asphaltenic hydrocarbon comprises a hydrocarbon mixture having one or more aromatic compounds, one or more naphthenic compounds, or a mixture of both.

10. The method of claim 8, wherein the cooling media flows in the cooling channel, thereby causing the asphaltenic pellets to course towards a conveyor system configured to separate the asphaltenic pellets from the cooling media.

11. The method of claim 8, wherein the cooling media has a temperature of from about 0° C. to about 95° C.

12. The method of claim 8, further comprising recycling at least a portion of the cooling media back into the cooling channel.

13. The method of claim 8, wherein the cooling media comprises water, brine, C₅ to C₉ alkane hydrocarbons, or a mixture thereof.

14. A system for the pelletization of a heavy hydrocarbon, comprising:
a drop former having a stator disposed within a rotary outer drum, wherein the rotary outer drum rotates concentrically about the stator and defines a plurality of perforations configured to coincide cyclically with a channel mounted in the stator, the stator being configured to receive and extrude a molten heavy hydrocarbon out of the channel and through the outer drum to form droplets;
a conveyor disposed adjacent to and below the drop former and configured to receive the droplets from the drop former;
a cooling channel having a cooling media flowing therein and configured to receive the droplets from the conveyor, wherein the cooling media quenches the droplets into solidified pellets and causes the pellets to course through the cooling channel; and
a conveyor system configured to receive and separate the pellets from the cooling media.

15. The system for claim 14, wherein the heavy hydrocarbon is an asphaltene.

16. The system for claim 14, wherein the conveyor is disposed at a decline.

17. The system for claim 16, wherein a first end of the conveyor is adjacent the drop former to receive the droplets and a second end of the conveyor is at least partially immersed in the cooling media of the cooling channel.

18. The system for claim 14, wherein the conveyor system comprises a screen configured to separate at least a portion of the cooling media from the pellets, thereby allowing the cooling media to accumulate in a reservoir.

19. The system for claim 18, wherein at least a portion of the cooling media in the reservoir is recycled back through the cooling channel.

20. The system for claim 19, wherein the cooling media recycled to the cooling channel is further passed through at least one heat transfer unit configured to reduce the temperature of the cooling media.
